(19) United States
(12) Patent Application Publication
(10) Pub. No.: US 2024/0415726 A1
(43) Pub. Date: Dec. 19, 2024

(54) Back Scratching Device

(71) Applicant: Geraldine Sellars, Henderson, KY (US)

(72) Inventor: Geraldine Sellars, Henderson, KY (US)

(21) Appl. No.: 18/211,550

(22) Filed: Jun. 19, 2023

(51) Int. Cl. A61H 7/00

(52) U.S. Cl. CPC A61H 7/002; A61H 2201/0123; A61H 2201/1692; A61H 2205/081

(57) ABSTRACT

A back scratching device for scratching a user's back includes a back scratching unit which includes a scratching panel perpendicularly oriented with a pair of engaging panels. A door can be extended between the pair of engaging panels to facilitate a user to position their back against the scratching panel. A pair of engaging pads is bonded to a respective one of the engaging panels to frictionally engage the door for retaining the back scratching unit on the door. A plurality of nubs is each positioned on the back scratching unit to scratch the user's back when the user leans against the back scratching unit.

### CROSS-REFERENCE TO RELATED APPLICATIONS

Not Applicable

### STATEMENT REGARDING FEDERALLY SPONSORED RESEARCH OR DEVELOPMENT

Not Applicable

### Incorporation-by-Reference of Material Submitted on a Compact Disc or as a Text File Via the Office Electronic Filing System

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to scratching devices and more particularly pertains to a new scratching device for scratching a user's back. The device includes a pair of engagement panels attached to a scratching panel. The device includes a pair of engaging pads attached to a respective engagement panel for frictionally engaging the door for retaining the back scratching unit on the door. The device includes a plurality of nubs disposed on the back scratching unit for scratching a user's back when the user leans against the back scratching unit.

### (2) DESCRIPTION OF RELATED ART INCLUDING INFORMATION DISCLOSED UNDER 37 CFR 1.97 AND 1.98

The prior art relates to scratching devices including a variety of back scratchers structured to be mounted to either an inside corner or an outside corner, a plurality of back scratchers that has a curved scratching element. In no instance does the prior art discloses a back scratching device that can be removably mounted to a door and which includes a planar scratching surface.

### BRIEF SUMMARY OF THE INVENTION

An embodiment of the disclosure meets the needs presented above by generally comprising a back scratching unit which includes a scratching panel perpendicularly oriented with a pair of engaging panels. A door can be extended between the pair of engaging panels to facilitate a user to position their back against the scratching panel. A pair of engaging pads is bonded to a respective one of the engaging panels to frictionally engage the door for retaining the back scratching unit on the door. A plurality of nubs is each positioned on the back scratching unit to scratch the user's back when the user leans against the back scratching unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a back scratching device according to an embodiment of the disclosure.

FIG. 2 is a front view of an embodiment of the disclosure.

FIG. 3 is a back view of an embodiment of the disclosure.

FIG. 4 is a left side view of an embodiment of the disclosure.

FIG. 5 is a bottom view of an embodiment of the disclosure.

FIG. 6 is a perspective in-use view of an embodiment of the disclosure.

### DETAILED DESCRIPTION OF THE INVENTION

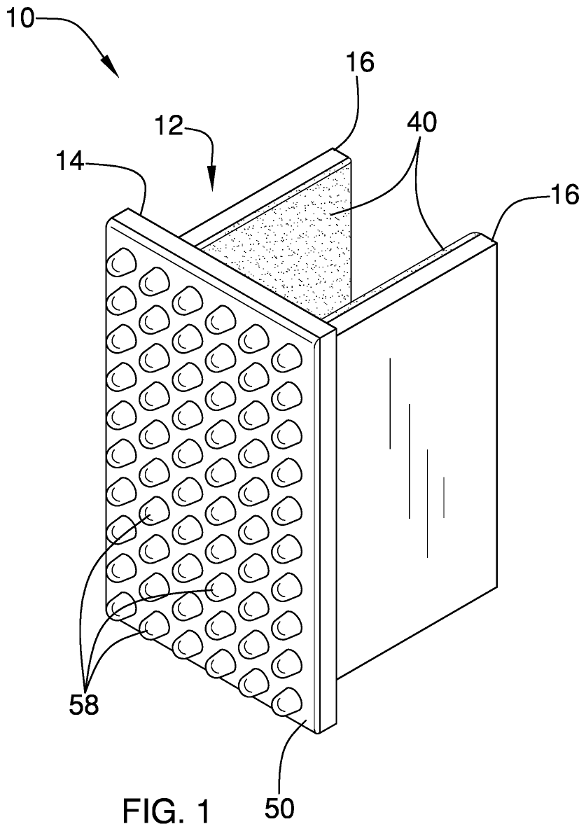

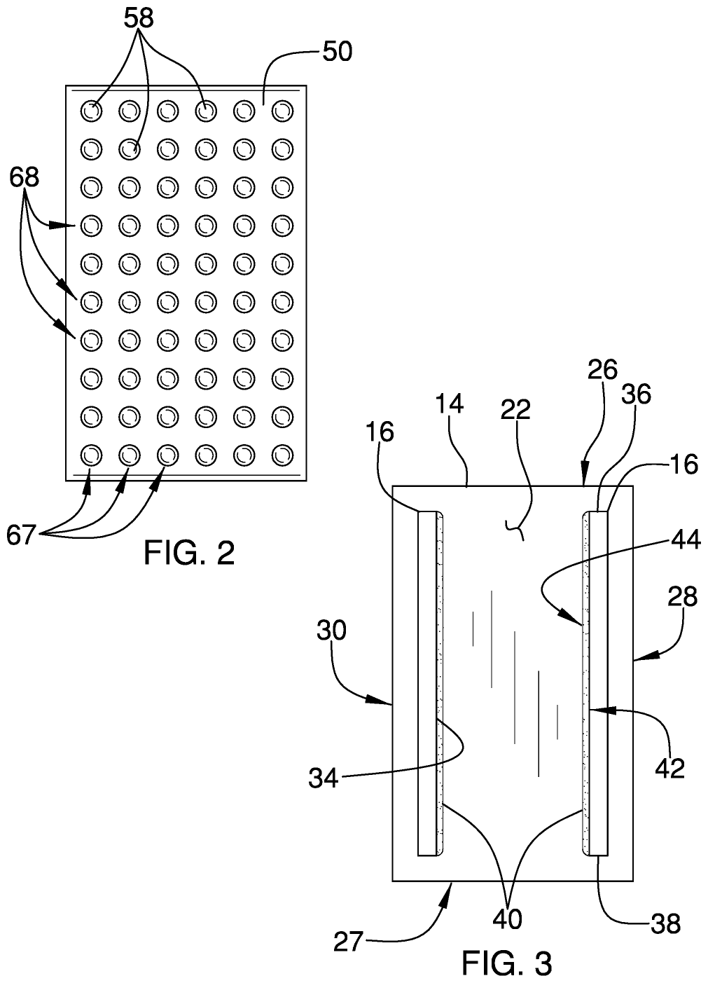

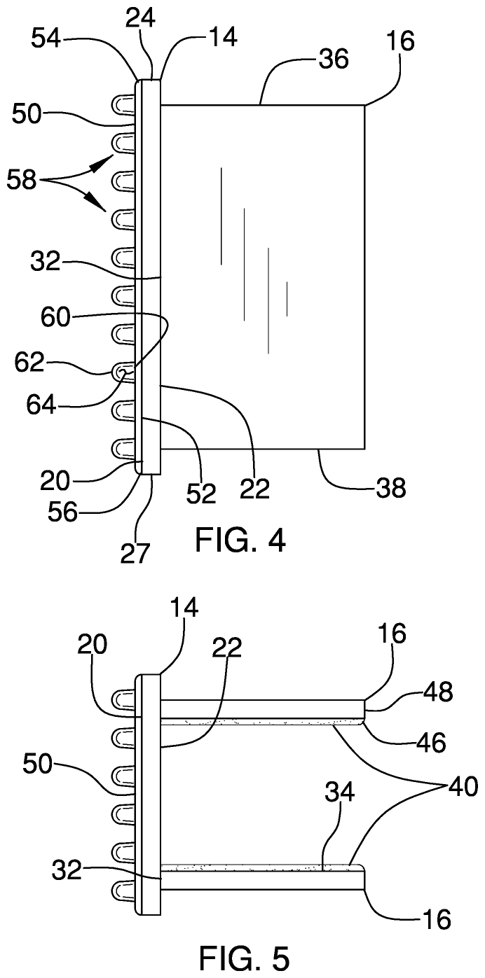

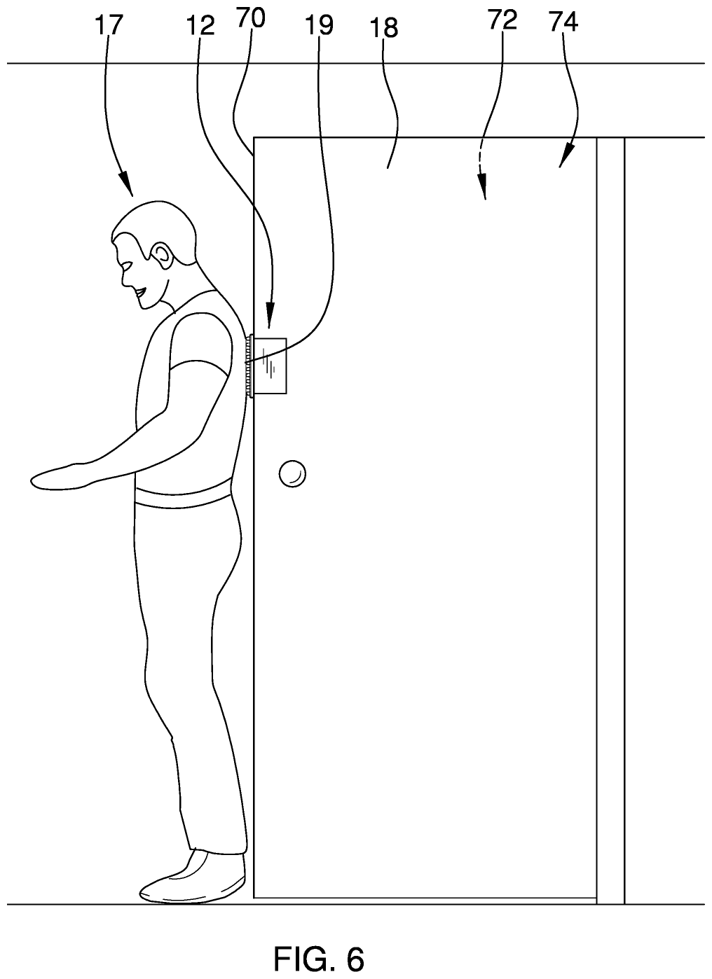

With reference now to the drawings, and in particular to FIGS. 1 through 6 thereof, a new scratching device embodying the principles and concepts of an embodiment of the disclosure and generally designated by the reference numeral 10 will be described.

As best illustrated in FIGS. 1 through 6, the back scratching device 10 generally comprises a back scratching unit 12 that has a scratching panel 14 which is perpendicularly oriented with a pair of engaging panels 16. The engaging panels 16 are spaced apart from each other thereby facilitating a door 18 in room to be extended between the pair of engaging panels 16 having the scratching panel 14 is exposed. In this way the scratching panel 14 is positioned to facilitate a user 17 to position their back 19 against the scratching panel 14. The door 18 may be an interior door or exterior door in the room of any conventional design and size.

The scratching panel 14 has a front surface 20, a back surface 22 and a perimeter edge 24 extending between the front surface 20 and the back surface 22; the perimeter edge 24 has a top side 26, a bottom side 27, a first lateral side 28 and a second lateral side 30. Each of the engaging panels 16 has a front edge 32 and a first surface 34 and the front edge 32 of each of the engaging panels 16 is attached to the back surface 22 of the scratching panel 14. Furthermore, each of the engaging panels 16 extends substantially between the top side 26 and the bottom side 27 of the perimeter edge 24 of the scratching panel 14; a top edge 36 and a bottom edge 38 of each of the engaging panels 16 is evenly spaced from a respective one of the top side 26 and the bottom side 27 of the perimeter edge 24 of the scratching panel 14. Each of the engaging panels 16 is spaced inwardly from a respective one of the first lateral side 28 and the second lateral side 30 of the perimeter edge 24 of the scratching panel 14 having the first surface 34 of each of the pair of engaging panels 16 being directed toward each other.

A pair of engaging pads 40 is provided and each of the engaging pads 40 is bonded to a respective one of the engaging panels 16. In this way each of the engaging pads 40 frictionally engages the door 18 when the door 18 is positioned between the pair of engaging panels 16 for retaining the back scratching unit 12 on the door 18. Each of the engaging pads 40 has a front surface 42 and a back surface 44; the front surface 42 of each of the engaging pads 40 is bonded to the first surface 34 of the respective engaging panel 16. Additionally, the front surface 42 of each of the engaging pads 40 completely covers the first surface 34 of the respective engaging panel 16.

Each of the engaging pads 40 has a rear edge 46 that is aligned with a back edge 48 of the respective engaging panel 16. The rear edge 46 of each of the engaging pads 40 is rounded thereby inhibiting the rear edge 46 of each of the engaging pads 40 from catching on the door 18. Additionally, each of the pair of engaging pads 40 is comprised of a resiliently compressible material to enhance gripping the door 18. A scratch pad 50 is provided that has a rear surface 52 which is bonded to the front surface 20 of the scratching panel 14 having the rear surface 52 of the scratch pad 50 completely covering the front surface 20 of the scratching panel 14. The scratch pad 50 has an upper edge 54 that is aligned with the top side 26 of the perimeter edge 24 of the scratching panel 14. The scratch pad 50 has a lower edge 56 that is aligned with the bottom side 27 of the perimeter edge 24 of the scratching panel 14 and each of the upper edge 54 and the lower edge 56 of the scratch pad 50 is rounded.

A plurality of nubs 58 is provided and each of the plurality of nubs 58 is positioned on the back scratching unit 12 to scratch the user's back 19 when the user 17 leans against the back scratching unit 12. Each of the nubs 58 has a back end 60, a front end 62 and an outer surface 64 extending between the front end 62 and the back end 60. The back end 60 of each of the nubs 58 is bonded to a forward surface 66 of the scratch pad 50 and the front end 62 of each of the plurality of nubs 58 is rounded. The outer surface 64 of each of the plurality of nubs 58 tapers between the back end 60 and the front end 62. The plurality of nubs 58 is arranged in a plurality of columns 67 and rows 68 on the forward surface 66 of the scratch pad 50.

In use, the back scratching unit 12 is positioned on the door 18 such that a front edge 70 of the door 18 abuts the back surface 22 of the scratching panel 14 and each of the engaging pads 40 is compressed against a respective one of a left side 72 and a right side 74 of the door 18. In this way the back scratching unit 12 is retained on the door 18 at a selected height having the plurality of nubs 58 being exposed. Thus, the user 17 can rub their back 19 against the plurality of nubs 58 for scratching their back 19. Furthermore, the engaging pads 40 facilitate the back scratching unit 12 to be retained on the door 18 without the use of fasteners or adhesives.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A back scratching device being mountable to an edge of a door to facilitate a user to scratch their back, said device comprising:
a back scratching unit having a scratching panel being perpendicularly oriented with a pair of engaging panels, said pair of engaging panels being spaced apart from each other thereby facilitating a door in room to be extended between said pair of engaging panels having said scratching panel being exposed wherein said scratching panel is configured to be positioned to facilitate a user to position their back against said scratching panel;
a pair of engaging pads, each of said engaging pads being bonded to a respective one of said engaging panels thereby facilitating each of said engaging pads to frictionally engage the door when the door is positioned between said pair of engaging panels for retaining said back scratching unit on the door; and
a plurality of nubs, each of said plurality of nubs being positioned on said back scratching unit wherein each of said plurality of nubs is configured to scratch the user's back when the user leans against said back scratching unit.

2. The device according to claim 1, wherein:
said scratching panel has a front surface, a back surface and a perimeter edge extending between said front surface and said back surface, said perimeter edge having a top side, a bottom side, a first lateral side and a second lateral side;
each of said engaging panels has a front edge and a first surface, said front edge of each of said engaging panel being attached to said back surface of said scratching panel;
each of said engaging panels extends substantially between said top side and said bottom side of said perimeter edge of said scratching panel such that a top edge and a bottom edge of each of said engaging panels is evenly spaced from a respective one of said top side and said bottom side of said perimeter edge of said scratching panel; and
each of said engaging panels is spaced inwardly from a respective one of said first lateral side and said second lateral side of said perimeter edge of said scratching panel having said first surface of each of said pair of engaging panels being directed toward each other.

3. The device according to claim 2, wherein:
each of said engaging pads has a front surface and a back surface;
said front surface of each of said engaging pads is bonded to said first surface of said respective engaging panel having said front surface of each of said engaging pads completely covering said first surface of said respective engaging panel;
each of said engaging pads has a rear edge being aligned with a back edge of said respective engaging panel, said rear edge of each of said engaging pads being rounded thereby inhibiting said rear edge of each of said engaging pads from catching on the door; and
each of said pair of engaging pads is comprised of a resiliently compressible material to enhance gripping the door.

4. The device according to claim 2, wherein:
said device includes a scratch pad having a rear surface being bonded to said front surface of said scratching panel having said rear surface completely covering said front surface of said scratching panel;
said scratch pad has an upper edge being aligned with said top side of said perimeter edge of said scratching panel;
said scratch pad has a lower edge being aligned with said bottom side of said perimeter edge of said scratching panel; and
each of said upper edge and said lower edge of said scratch pad is rounded.

5. The device according to claim 4, wherein:
each of said nubs has a back end, a front end and an outer surface extending between said front end and said back end, said back end of each of said nubs being bonded to a forward surface of said scratch pad;
said front end of each of said plurality of nubs is rounded;
said outer surface of each of said plurality of nubs tapers between said back end and said front end; and
said plurality of nubs is arranged in a plurality of columns and rows on a forward surface of said scratch pad.

6. A back scratching device being mountable to an edge of a door to facilitate a user to scratch their back, said device comprising:
a back scratching unit having a scratching panel being perpendicularly oriented with a pair of engaging panels, said pair of engaging panels being spaced apart from each other thereby facilitating a door in room to be extended between said pair of engaging panels having said scratching panel being exposed wherein said scratching panel is configured to be positioned to facilitate a user to position their back against said scratching panel, said scratching panel having a front surface, a back surface and a perimeter edge extending between said front surface and said back surface, said perimeter edge having a top side, a bottom side, a first lateral side and a second lateral side, each of said engaging panels having a front edge and a first surface, said front edge of each of said engaging panel being attached to said back surface of said scratching panel, each of said engaging panels extending substantially between said top side and said bottom side of said perimeter edge of said scratching panel such that a top edge and a bottom edge of each of said engaging panels is evenly spaced from a respective one of said top side and said bottom side of said perimeter edge of said scratching panel, each of said engaging panels being spaced inwardly from a respective one of said first lateral side and said second lateral side of said perimeter edge of said scratching panel having said first surface of each of said pair of engaging panels being directed toward each other;
a pair of engaging pads, each of said engaging pads being bonded to a respective one of said engaging panels thereby facilitating each of said engaging pads to frictionally engage the door when the door is positioned between said pair of engaging panels for retaining said back scratching unit on the door, each of said engaging pads having a front surface and a back surface, said front surface of each of said engaging pads being bonded to said first surface of said respective engaging panel having said front surface of each of said engaging pads completely covering said first surface of said respective engaging panel, each of said engaging pads having a rear edge being aligned with a back edge of said respective engaging panel, said rear edge of each of said engaging pads being rounded thereby inhibiting said rear edge of each of said engaging pads from catching on the door, each of said pair of engaging pads being comprised of a resiliently compressible material to enhance gripping the door;
a scratch pad having a rear surface being bonded to said front surface of said scratching panel having said rear surface completely covering said front surface of said scratching panel, said scratch pad having an upper edge being aligned with said top side of said perimeter edge of said scratching panel, said scratch pad having a lower edge being aligned with said bottom side of said perimeter edge of said scratching panel, each of said upper edge and said lower edge of said scratch pad being rounded; and
a plurality of nubs, each of said plurality of nubs being positioned on said back scratching unit wherein each of said plurality of nubs is configured to scratch the user's back when the user leans against said back scratching unit, each of said nubs having a back end, a front end and an outer surface extending between said front end and said back end, said back end of each of said nubs being bonded to a forward surface of said scratch pad, said front end of each of said plurality of nubs being rounded, said outer surface of each of said plurality of nubs tapering between said back end and said front end, said plurality of nubs being arranged in a plurality of columns and rows on a forward surface of said scratch pad.
